(19) United States
(12) Patent Application Publication
(10) Pub. No.: US 2003/0110254 A1
(43) Pub. Date: Jun. 12, 2003

(54) Storage apparatus

(75) Inventors: Takahiro Fujita, Yokohama (JP); Manabu Kitamura, Yokohama (JP); Kyosuke Achiwa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/079,599

(22) Filed: Feb. 19, 2002

(30) Foreign Application Priority Data
Dec. 12, 2001 (JP) 2001-378024

(51) Int. Cl. G06F 15/173

(52) U.S. Cl. 709/224

(57) ABSTRACT

A storage apparatus in a computer system, which includes a computer usage-status information reporting unit. When a computer makes an I/O request to the storage apparatus, the computer and a device for which I/O has been requested by the computer are identified, and the amount of data that has been transferred when I/O operations are performed, a cache hit ratio, and a processing time are measured. Then, the above information obtained and the above values measured are stored in the computer usage-status information in the storage apparatus. By using the computer usage-status information reporting unit, the stored computer usage-status information is referenced from the outside of the storage apparatus.

### BACKGROUND OF THE INVENTION

The present invention relates to a storage apparatus used in a computer system. More specifically, the invention relates to a storage apparatus used in a storage area network (hereinafter referred to as an “SAN”), and a method of providing service by a storage service provider that uses the storage apparatus.

The performance of the computer system such as a data base or a streaming server that handles a large amount of data greatly depends on data transfer performance between the computer that performs processing on data and the storage apparatus in which the data is stored. This performance is hereinafter referred to as “I/O performance”. In order to maintain the performance of the computer system, it was therefore necessary to monitor the I/O performance on the computer and the storage apparatus in the computer system.

Conventionally, the I/O performance when I/O operations are performed between the computer and the storage apparatus was monitored as follows: first, agents that monitor the I/O performance are operated on the computers to be monitored, and then information on the I/O performance for the respective computers is collected. Thereafter, the I/O performance information on the respective computers, collected by the agents is collectively managed by a management server.

### SUMMARY OF THE INVENTION

Conventional monitoring of the I/O performance of the computer system by the agent has the disadvantage that the computer resources that should be originally used by the computer system are consumed by the agent. Further, since the agents should be integrated into all the computers that require monitoring of their I/O performance, the management costs of the overall computer system will increase.

The storage apparatus, on the other hand, includes a cache memory intended for improving the performance of the storage apparatus. Accordingly, in the computer system, the cache hit rate of the cache memory included in the storage apparatus in the computer system is also a main factor for determining I/O performance. However, since the cache memory is controlled in the storage apparatus, it is difficult for the conventional agent running on a computer to collect information on the cache memory. It means that, according to the conventional art, information about the I/O performance of the computer system that even contains performance information inside the storage apparatus, such as the cache hit rate, cannot be obtained.

Still further, for a storage service provider (hereinafter referred to as an “SSP”) that provides the storage capacity of the storage apparatus to customers, it becomes important to guarantee a certain level of the access performance to the storage apparatus. According to the conventional art, however, in order to measure the access performance, it is necessary to integrate the agents into the respective computers of the customers. Nevertheless, if the computer of a customer is disposed in a remote location from the SSP, even integration of the agent into the computer is difficult. In addition, even if the agent can be integrated into the customer computer, this integration imposes an additional cost on the customer. Accordingly, it is difficult for the SSP to use the computers of the customers to obtain the I/O information. For this reason, the SSP could not charge to the customer on the basis of the access performance of the storage apparatus that was made available to the customers. More specifically, a disparity in charges cannot be made between the customer who uses much processing capability of the available storage apparatus and the customer who does not use so much processing capability of the storage apparatus.

An object of the present invention is to obtain I/O information, in particular performance information with inside a storage apparatus information, in a computer system without operating an agent on the computer, thereby monitoring the overall I/O performance of the computer system.

A further object of the present invention is to provide charging service according to the amount of data that has been transferred, thereby getting a wide spectrum of users.

In order to achieve the above-mentioned objects, a storage apparatus according to the present invention, connected to a plurality of computers via a network, comprises:

interface ports connected to the network for receiving I/O requests from the plurality of computers;

a controller connected to the interface ports;

storage devices connected to the controller; and

memory in which information on the I/O requests received at the interface ports is stored.

Further, the storage apparatus comprises means for outputting the information on the I/O requests stored in the memory to the outside of the storage apparatus. Specifically, the storage apparatus performs a computer usage-status information reporting process for reference of the information on the I/O requests from the outside of the storage apparatus. The information on the I/O requests includes such information as a computer that has made an I/O request to the storage apparatus, a device for which I/O has been requested, an amount of data that has been transferred when I/O operations are performed, the cash hit rate, and a processing time.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the configuration of a computer system according to the present invention;

FIG. 2 shows an FCP command format;

FIG. 3 shows an FCP_CDB read command format;

FIG. 4 shows a read command format on the basis of a shared file protocol;

FIG. 5 is a block diagram showing processes to be performed by a storage apparatus;

FIG. 6 is a table showing computer usage-status information managed by the storage apparatus;

FIG. 7 is a flowchart showing a requested block I/O process and information acquisition process requested from a computer;

FIG. 8 is a flowchart showing a requested file I/O process and information acquisition process requested from a computer;

FIG. 9 is a flowchart showing a data transfer process to be performed by physical device control means; and

FIG. 10 shows tables of customer management information and customer usage-status information managed by a management computer.

### DESCRIPTION OF THE EMBODIMENT

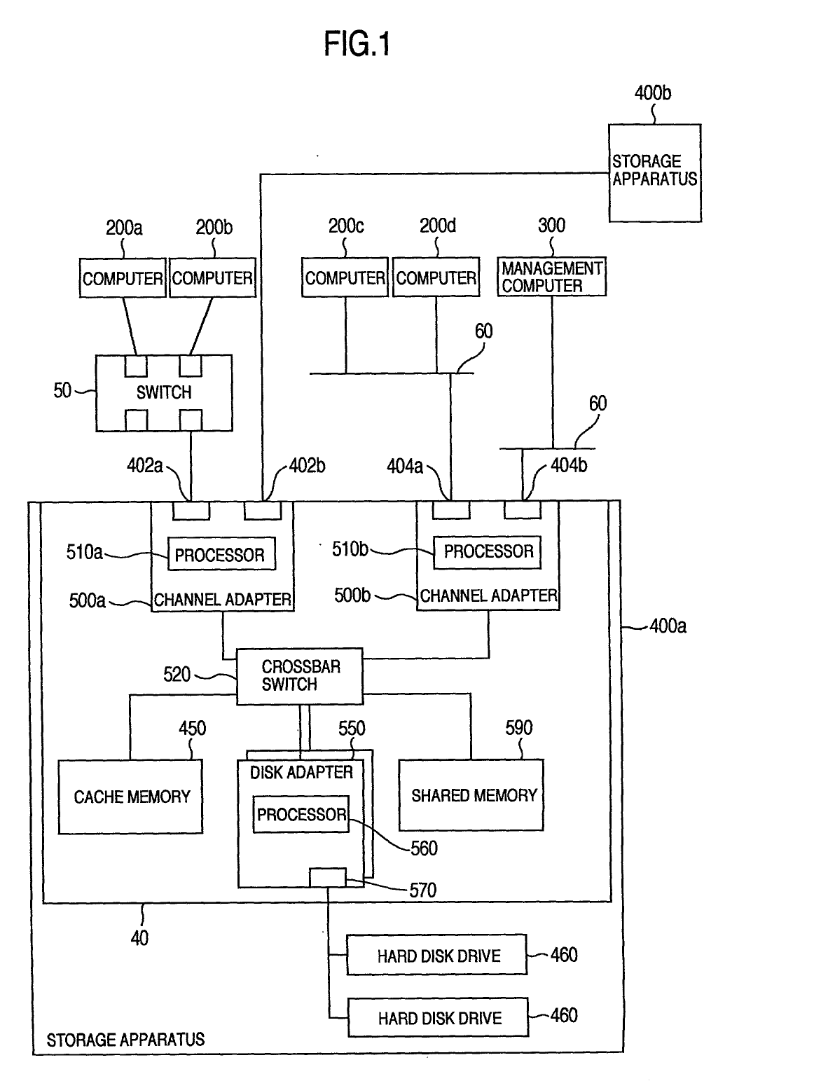

FIG. 1 is a block diagram showing a computer system according to an embodiment of the present invention. A computer system 1 comprises computers 200a, 200b, 200c, 200d (hereinafter collectively referred to as computers 200), a management computer 300, a fibre channel switch 50, an Internet Protocol (hereinafter referred to as an “IP”) network 60, a storage apparatus 400a, and a storage apparatus 400b (hereinafter collectively referred to as storage apparatuses 400).

The storage apparatus 400a is connected to the computers 200a and 200b through the fibre channel switch 50. Further, the storage apparatus 400a is connected to the computers 200c and 200d through the IP network 60. Still further, the storage apparatus 400a is connected to the management computer 300 through the IP network 60.

The storage apparatus 400b is disposed in a remote location from the storage apparatus 400a. The same data as in the storage apparatus 400a is stored in the storage apparatus 400b. With this arrangement, even if the data in the storage apparatus 400a is destroyed due to a disaster or the like, the data is protected in the storage apparatus 400b.

The computers 200a and 200b connected to the storage apparatus 400a through the fibre channel switch 50 performs data transfer using an SCSI Protocol over Fibre Channel (hereinafter referred to as an “FCP”) protocol. The computers 200c and 200d connected to the storage apparatus 400a through the IP network 60 performs data transfer using a file sharing protocol.

The storage apparatus 400 comprises a controller 40 and hard disk drives 460. The controller 40 comprises channel adapters 500a and 500b (hereinafter collectively referred to as channel adapters 500), a cache memory 450, a shared memory 50, a disk adapter 550, and a crossbar switch 520.

The channel adapters 500, cache memory 450, shared memory 590, and disk adapter 550 are mutually connected via the crossbar switch 520.

The hard disk drives 460 are connected to the disk adapter 550 in the controller 40 through a port 570. The storage apparatus 400 may include a plurality of the disk adapters 550. In this case, a plurality of the disk adapters 550 is connected to the crossbar switch 520, respectively. A plurality of the hard disk drives 460 is connected to each of the disk adapters 550. The disk adapter 550 controls transfer of data between the respective hard disk drives and other devices.

The channel adapter 500a comprises fibre channel ports 402a and 402b and a processor 510a. The channel adapter 500a receives I/O requests issued by the computers 200a and 200b on the basis of the FCP protocol through the fibre channel port 402a. The channel adapter 500a is also a controller, too that transfers data to and from the storage apparatus 400b through the fibre channel port 402b. Incidentally, it may also be so arranged that a plurality of the channel adapters 500a is provided.

The channel adapter 500b comprises IP network ports 404a and 404b and a processor 510b. The channel adapter 500b receives I/O requests issued by the computers 200c and 200d on the basis of the file sharing protocol through the IP network port 404a. The IP network port 404b is connected to the management computer 300. The channel adapter 500b transmits information on I/O operations from a computer 200 to the storage apparatus 400a, to the management computer 300 through the IP network port 404b.

The storage apparatus 400a includes a plurality of logical devices that are logical storage extents and shared directories. The storage apparatus 400a determines to which logical device or shared directory an I/O request from a computer 200 is targeted, on the basis of the contents of a command for the I/O request from the computer 200.

Further, the storage apparatus 400a processes various I/O request commands transmitted from a computer 200, and monitors I/O performance when I/O operations are performed between the computer 200 and the storage apparatus 400a. The storage apparatus 400a can also monitor I/O performance when I/O operations are performed between the storage apparatus 400a and the storage apparatus 400b.

Now, the I/O request command exchanged between a computer 200 and the storage apparatus 400a will be briefly described.

Under the FCP, the I/O request command is transmitted and received between a computer 200 and the storage apparatus 400a by the exchange of fibre channel frames. The fibre channel frame comprises a frame header and a data unit. The frame header contains an address assigned to the fibre channel port of the computer 200 and an address assigned to the fibre channel port 402a of the storage apparatus 400a. The I/O request command is transmitted and received between the fibre channel ports specified by the addresses contained in the frame headers.

The fibre channel port addresses are determined as follows. A World Wide Name (hereinafter referred to as a “WWN”) that is unique all over the world is assigned to each of the fibre channel ports. Before data transfer using the fibre channel is performed, a negotiation using the WWNs is performed between associated fibre channel ports to determine the addresses of the respective fibre channel ports. In order to obtain the addresses of the fibre channel ports from the WWNs, the computer and the storage apparatus hold information on a relationship between the WWNs for the fibre channel ports and the assigned addresses determined in the negotiation.

The I/O request command is stored in the data unit.

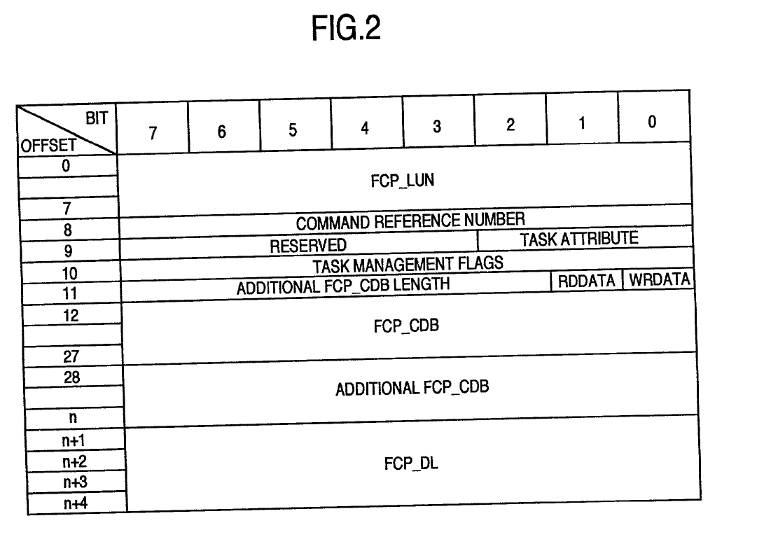

FIG. 2 is an illustrative diagram showing the format of the I/O request command stored in the data unit. FCP_LUN is a field where information designating a logical device for which I/O is requested is stored. FCP_CDB is a field where information designating the command to be issued to the designated logical device is stored. Other fields are the fields where information to be used for controlling the designated command is stored.

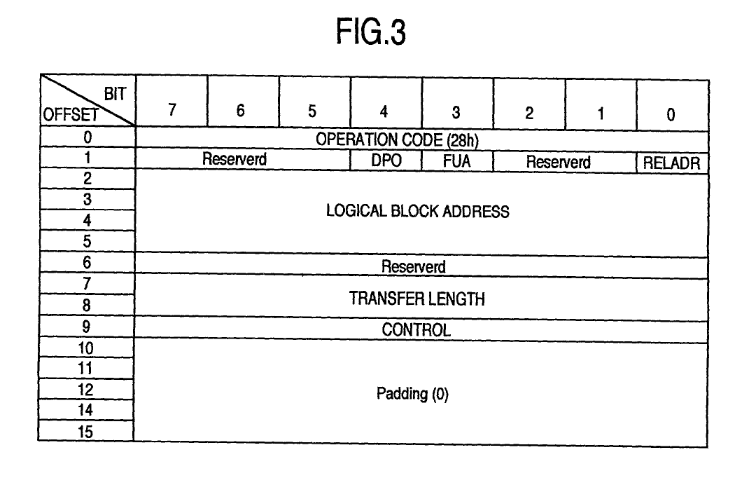

FIG. 3 is an illustrative diagram showing the contents of the FCP_CDB field designating a READ (10) command that is one of read I/O request commands. OPERATION CODE is a field where an identifier for specifying the type of a command is stored. In this diagram, 28h, which indicates the READ (10) command is stored in the OPERATION CODE. LOGICAL BLOCK ADDRESS is a field where information specifying the addresses of blocks from which data is read is stored. TRANSFER LENGTH is a field where information specifying the number of data blocks to be read is stored. In the FCP_CDB field, in addition to the READ (10) command, commands such as READ (6), Write (6), and Write (10) commands can also be designated. Even when other command is designated, the addresses of blocks to be read or written and the number of the blocks to be read or written are specified in FCP_CDB field.

The storage apparatus 400a identifies the computer 200 that has issued an I/O request to the storage apparatus 400a on the basis of a source address stored in the fibre channel frame. Further, the storage apparatus 400a identifies a logical device associated with the I/O request issued by the computer 200 on the basis of a destination address stored in the fibre channel frame and information in the FCP_LUN field in the data unit. Still further, the storage apparatus 400a calculates the amount of data that has been transferred according to the issued I/O request, on the basis of the number of blocks to be read or written, specified in the FCP_CDB field stored in the data unit. Specifically, the storage apparatus 400a multiplies the number of the blocks specified in the FCP_CDB field by the number of bytes per block.

Next, a Common Internet File System (hereinafter referred to as a “CIFS”), which is one of the file sharing protocols, will be described.

In the CIFS, I/O request commands are received and transmitted between a computer 200 and the storage apparatus 400a by exchange of IP datagrams. An IP datagram comprises an IP header and a data unit. An IP header contains an IP address assigned to a network port of the computer 200 and an IP address assigned to a network port of the storage apparatus 400a. The I/O request commands are received and transmitted between the network ports specified by the IP addresses contained in the IP headers.

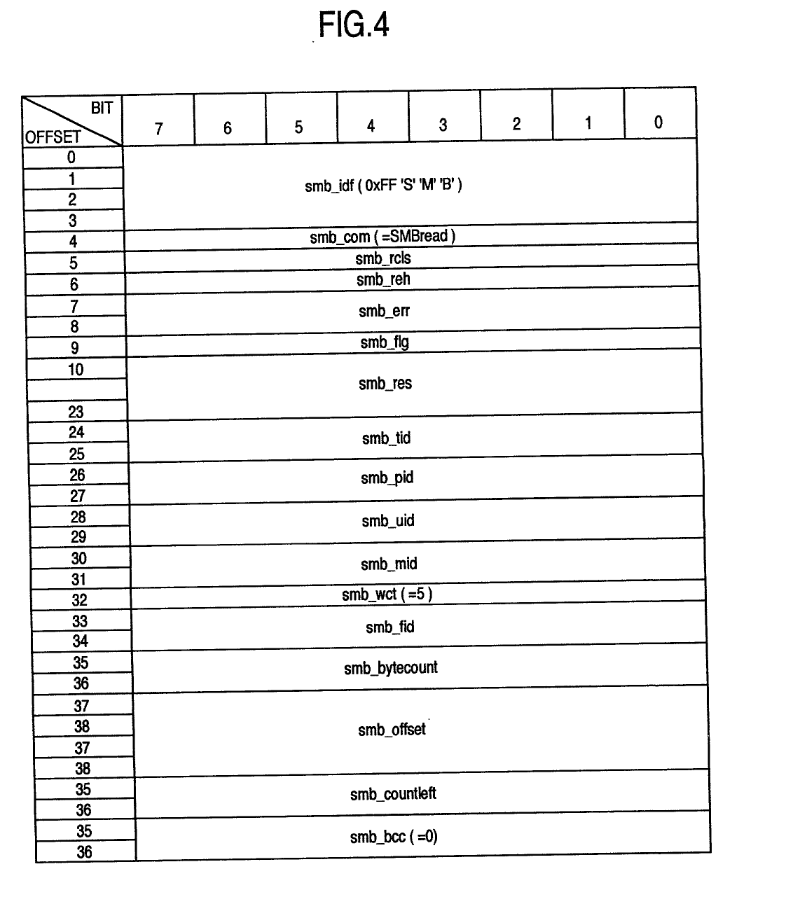

FIG. 4 is an illustrative diagram showing a data unit format when the I/O request command used in the CIFS is an SMB read command. smb_idf is a field where an identifier indicating that the command follows a CIFS protocol are stored. smb_com is a field where an identifier specifying the type of the I/O request command is stored. Referring to FIG. 4, the identifier designating the SMBread command is stored. symb_tid is a field where an identifier indicating a shared directory inside the storage apparatus 400a is stored. The storage apparatus 400a assigned specific values to the respective shared directories. By specifying a value assigned to an associated shared directory in the smb_tid field, a computer 200 designates a shared directory for which I/O is requested, from a plurality of the shared directories that are made available from the storage apparatus 400a.

smb_fid is a field where a 16-bit signed integer specifying a file from which data is read is stored. symb_bytecount is a field where a 16-bit unsigned integer specifying the amount of the data to be read is stored. symb_offset is a field in which a 32-bit unsigned integer indicating the position of a file pointer from which reading of the data is started is stored. Incidentally, read and write commands other than the SMBread command can also be designated in the data unit. By means of these commands as well, the smb_tid field can be used to specify a shared directory, and the amount of data to be read or written can be specified.

The storage apparatus 400a identifies the computer 200 that has issued an I/O request to the storage apparatus 400a, on the basis of a source address stored in the IP header of the IP datagram. Further, from a plurality of the shared directories, the storage apparatus 400a identifies a shared directory for which I/O has been requested by the computer 200. This operation is performed on the basis of a value in the smb_tid field in the data unit and a destination address stored in the IP header of the IP datagram. Still further, the storage apparatus 400a determines the amount of data to be transferred according to the I/O request, on the basis of a value stored in the smb_bytecount field in the data unit of the IP datagram.

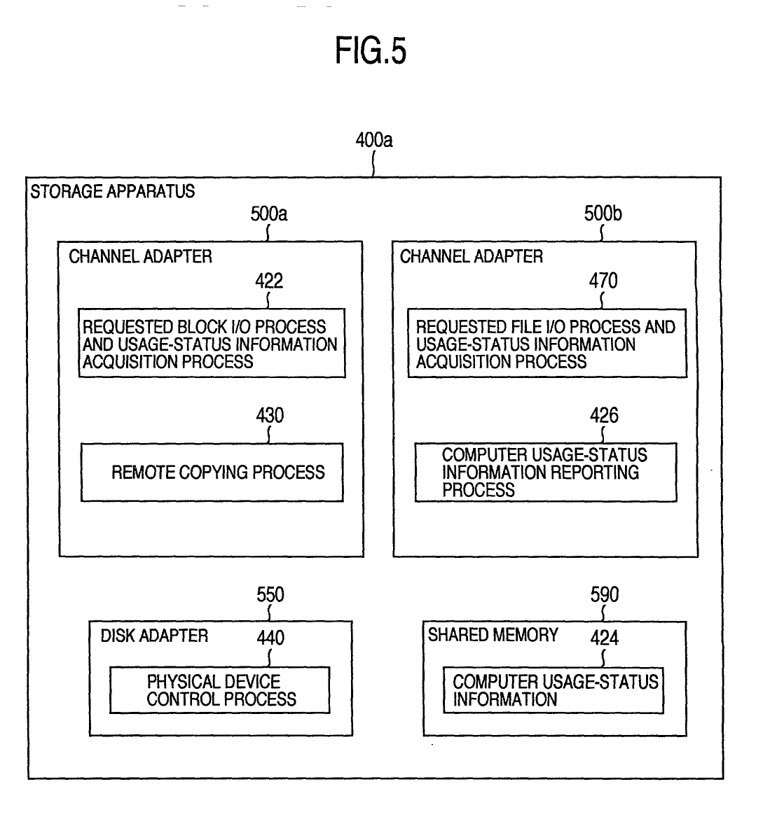

FIG. 5 is a block diagram schematically showing the processes to be performed by the storage apparatus 400a according to the present invention. The channel adapter 500a of the storage apparatus 400a performs a requested block I/O process and usage-status information acquisition process 422 and a remote copying process 430. The channel adapter 500b performs a computer usage-status information reporting process 426 and a requested file I/O process and usage-status information acquisition process 470. The disk adapter 550 performs a physical device control process 440. Computer usage-status information 424 required for executing these processes is stored in the shared memory. Incidentally, these processes may be performed by the devices that are different from those described above.

The channel adapter 500a that has received an I/O request from the computer 200a or 200b starts the requested block I/O process and usage-status information acquisition process 422 in order to obtain information on I/O operations requested from the computer 200a or 200b. The channel adapter 500a performs the remote copying process 430 if necessary. The channel adapter 500a stores the obtained I/O information in the shared memory 590 as the computer usage-status information 424. The requested block I/O process and usage-status information acquisition process 422 will be described in detail below. The remote copying process 430 is the process of copying data stored in the storage apparatus 400a to a different storage apparatus, such as the storage apparatus 400b in this embodiment.

Further, the channel adapter 500a transmits information on the I/O request to the disk adapter 550. Specifically, the information on the I/O request is the information that associates a logical device identifier specified in the FCP_LUN field and a shared directory specified in the smb_tid field with devices in the storage apparatus 400.

The disk adapter 550 performs the physical device control process 440 on the basis of information on the I/O request sent from the channel adapter 500a.

The physical device control process 440 is the process to control the cache memory 450 and the hard disk drives 460. Specifically, when receiving the information on the I/O request from the channel adapter 500a, the disk adapter 550 controls data transfer between the devices designated by the received information. Specifically, the disk adapter 550 controls data transfer between the cache memory 450, hard disk drive 460, and channel adapter 500a. The disk adapter 550 controls a plurality of the hard disk drives 460 on the basis of a RAID technology. With this arrangement, the reliability and performance of the hard disk drive 460 is improved. Further, the disk adapter 550 stores frequently accessed data in the cache memory 450. Since data transfer to the cache memory 450 is faster than data transfer to the hard disk drive 460, use of the cache memory 450 improves data transfer performance.

The channel adapter 500b that has received an I/O request from the computer 200c or 200d starts the requested file I/O process and usage-status information acquisition process 470 to obtain information on I/O operations requested from the computer 200c or 200d. The channel adapter 500b performs subsequent processes in the same way as the channel adapter 500a. It may also be so arranged that the channel adapter 500b can perform the remote copying process, too.

The computer usage-status information reporting process 426 performed by the channel adapter 500b is the process whereby the computer usage-status information 424 stored in the shared memory 590 is outputted to the outside of the storage apparatus 400a. For example, the channel adapter 500b transmits the computer usage-status information 424 to the management computer 300 periodically. The computer usage-status information reporting process 426 is executed arbitrarily. For example, the channel adapter 500b may periodically output the computer usage-status information 424 to the management computer 300 or may output the computer usage-status information 424 in response to an inquiry from the management computer 300.

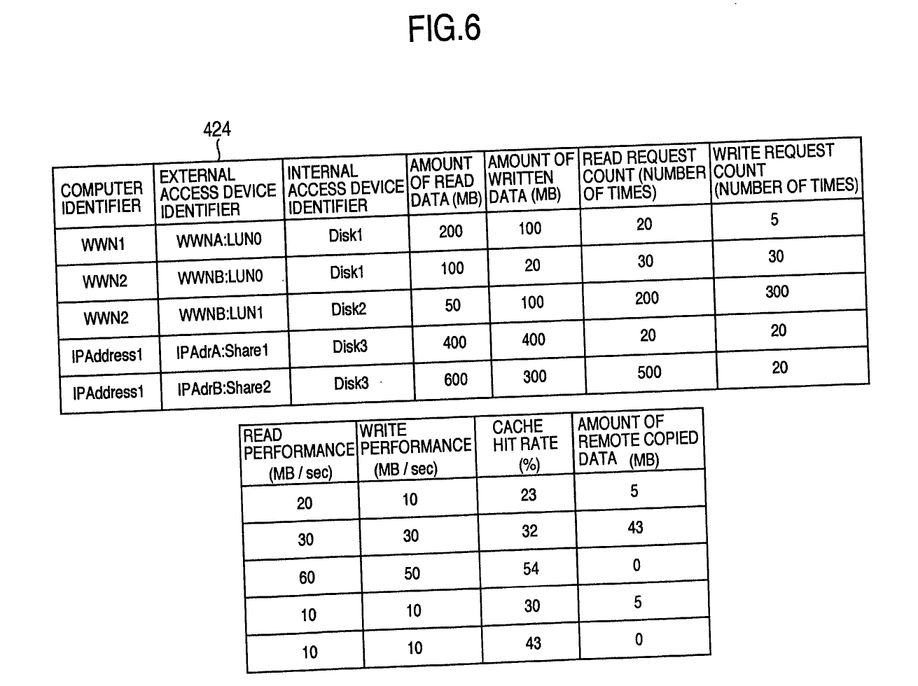

FIG. 6 is a table showing the contents of the computer usage-status information 424. The computer usage-status information 424 is updated and referenced by all the channel adapters. The computer usage-status information 424 includes information such as a computer identifier, an external access device identifier, an internal access device identifier, an amount of read data, an amount of written data, a read request count, a write request count, read performance, write performance, the cache hit rate, and an amount of remote copied data.

The computer identifier is an identifier indicating the computer that issues I/O request commands to the storage apparatus 400. In this embodiment, the computer identifier corresponds to the WWN of the fibre channel port of a computer 200 or the IP address of a computer 200.

The external access device identifier is an identifier indicating a logical device and a shared directory in the storage apparatus 400, for which I/O is requested by a computer 200. In this embodiment, the external access device identifier corresponds to an identifier indicating a Fibre Channel port and information in the FCP_LUN field, or an IP address and the name of a shared directory. The internal access device identifier is an identifier indicating an internal device corresponding to the external access device identifier.

The amount of read (written) data indicates the amount of data that has been read (written) by a computer 200 identified by a computer identifier, from (onto) a device identified by an access device identifier that corresponds to the computer identifier. Specifically, the amount of read (written) data is expressed in terms of megabytes (MB) such as 5000 MB.

The read (write) request count indicates the number of read (write) requests that have been issued from a computer 200 identified by a computer identifier to a device identified by an access device identifier corresponding to the computer identifier. Specifically, the read (write) request count is expressed in terms of the number of times such as 100 times.

The read (write) performance indicates an average data transfer rate when a read (write) I/O request issued from a computer 200 identified by a computer identifier is processed. It is the average data transfer rate for a period of time required for reading (writing) of data associated with the read (write) I/O operations from (onto) a device identified by an access device identifier corresponding to the computer identifier. Specifically, the read (write) performance is expressed in terms of megabytes per second, such as 50 MB/sec.

The cache hit rate indicates how much data that should be read or written is stored in the cache memory when a computer 200 identified by a computer identifier has issued the read or write request to a device identified by an access device identifier corresponding to the computer identifier. Specifically, the cache hit rate is expressed in terms of a percent, such as 50%.

The amount of remote copied data indicates the amount of data that has been copied to the storage apparatus 400b in the remote copying process 430 when a computer 200 identified by a computer identifier performs read or write operations to a device identified by an access device identifier corresponding to the computer identifier. The amount of remote copied data is expressed in terms of megabytes such as 300 MB.

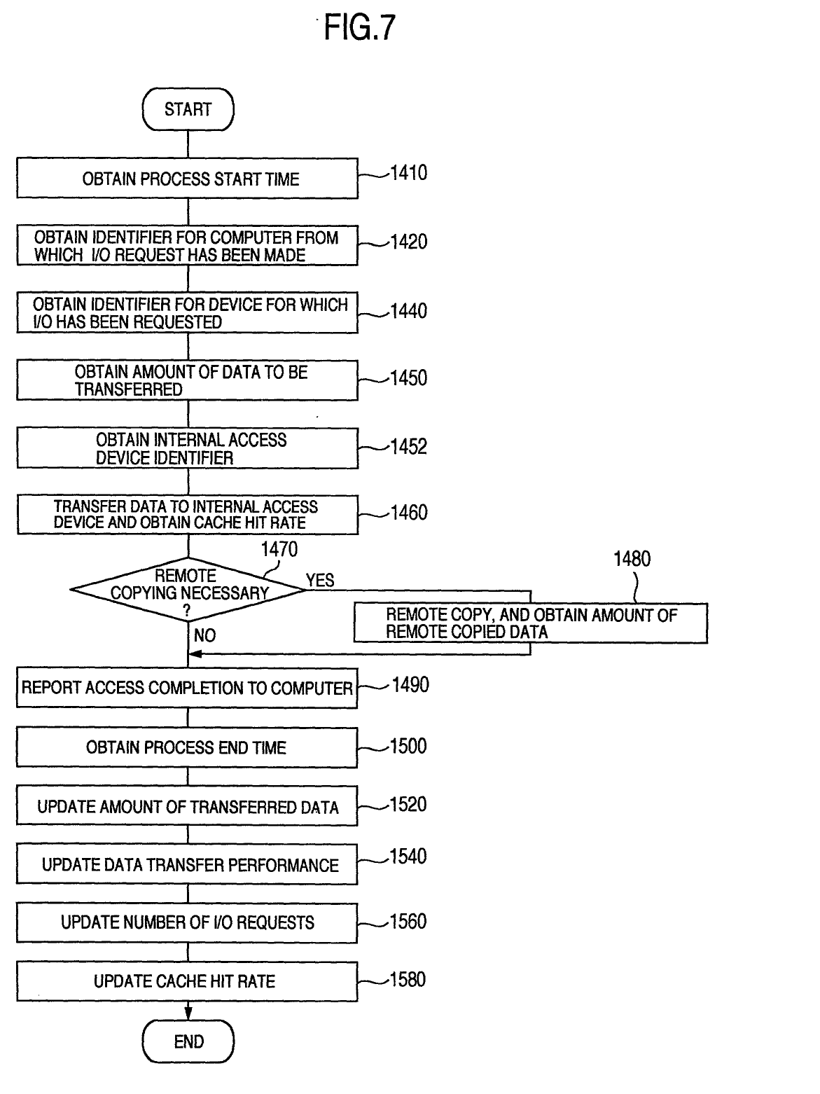

FIG. 7 is a flowchart showing steps of the requested block I/O process and usage-status information acquisition process 422 performed by the channel adapter 500a.

The channel adapter 500a obtains a time when a requested I/O process is started, in step 1410. Then, the channel adapter 500a obtains an identifier for the computer 200 from which an I/O request has been made, in step 1420. As already described, the identifier for the computer 200 from which the I/O request has been made is obtained from the frame header of a fibre channel frame.

Next, the channel adapter 500a obtains an identifier indicating a device for which I/O has been requested, in step 1440. The identifier indicating a logical device and a shared directory for which I/O has been requested is obtained from the I/O request frame. The identifier obtained is the external access device identifier, and in the case of the FCP, the identifier corresponds to an identifier indicating a fibre channel port and information in the FCP_LUN field.

Further, the channel adapter 500a obtains the amount of data to be transferred according to the I/O request, in step 1450. The amount of the data to be transferred is obtained from an I/O request command. In step 1452, the channel adapter 500a obtains an identifier for an internal access device in the storage apparatus 400a, corresponding to the external access device identifier obtained in step 1440.

In step 1460, the channel adapter 500a sends to the disk adapter 550 a request for data transfer to the internal access device in the storage apparatus identified in step 1452, and also obtains from the disk adapter 550 the cache hit rate in performing the data transfer. The process performed by the disk adapter 550 will be described in detail below.

The channel adapter 500a determines whether the remote copying process 430 is necessary for the device associated with the I/O request received, in step 1470. When the remote copying process 430 is necessary, the channel adapter 500a performs the remote copying process 430 for the I/O request received. At this point, the channel adapter 500a obtains the transfer amount of data that has been remote copied, in step 1480.

Thereafter, the channel adapter 500a sends response to the computer 200 that access to the device, or the I/O process has been completed in step 1490. The channel adapter 500a obtains a time when the I/O process has been completed, in step 1500.

Further, the channel adapter 500a updates the computer usage-status information 424 stored in the shared memory 590. Specifically, when the I/O request is a read I/O request, the amount of data that has been transferred according to the I/O request is added to the amount of read data. The average of the original read performance and the read performance when the I/O request has been made is also stored as new read performance. The read performance when the read I/O report has been made is obtained by dividing the amount of the data that has been transferred according to the I/O request by a difference between the process start time and the process end time. Then, the number of the read I/O requests is incremented by one. When the I/O request is a write I/O request, the amount of data that has been transferred according to the I/O request is added to the amount of written data. The average of the original write performance and the write performance when the I/O request has been made is also stored as new write performance. The write performance when the write I/O report has been made is obtained by dividing the amount of the data that has been transferred according to the I/O request by a difference between the process start time and the process end time. Then, the number of the write I/O requests is incremented by one.

The average of the cache hit rate at the time of this access and the preceding cache hit rate is calculated and stored in the shared memory 590 in step 1580.

The channel adapter 500a that has updated the computer usage-status information 424 terminates the process.

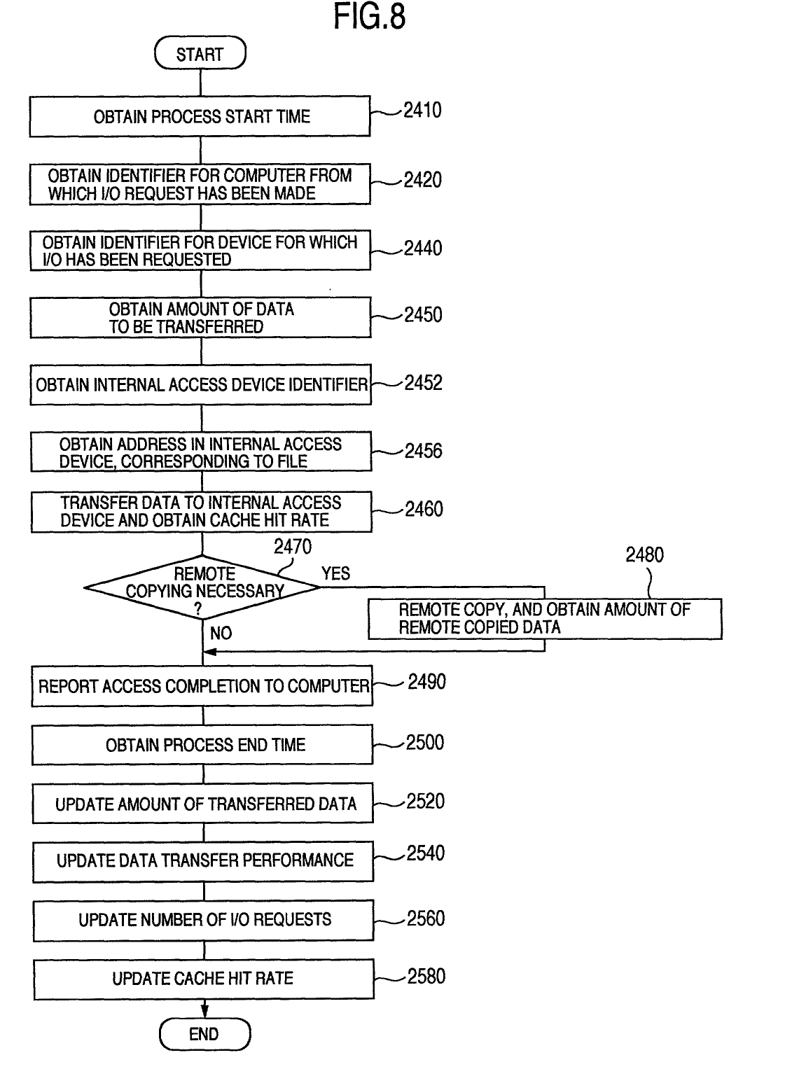

FIG. 8 is a flowchart showing the steps of a requested file I/O process and usage-status information acquisition process 470 performed by the channel adapter 500b.

The requested file I/O process and usage-status information acquisition process 470 performed by the channel adapter 500b is basically the same as the requested block I/O process and usage-status information acquisition process 422. However, the process 470 is different from the process 422 in the following respects. First, an identifier indicating the computer from which an I/O request has been made is obtained from the IP header of an IP datagram in step 2420. Further, an identifier indicating a logical device or a shared directory for which I/O has been requested is obtained from an I/O request frame, in step 2440. The identifier indicating the logical device and the shared directory is the external access device identifier. In the case of the shared file protocol, the identifier corresponds to an IP address and the name of a shared directory. Finally, the channel adapter 500b obtains an address in an internal device, corresponding to a file stored in the internal device, for which I/O has been requested by the computer 200, in step 2456.

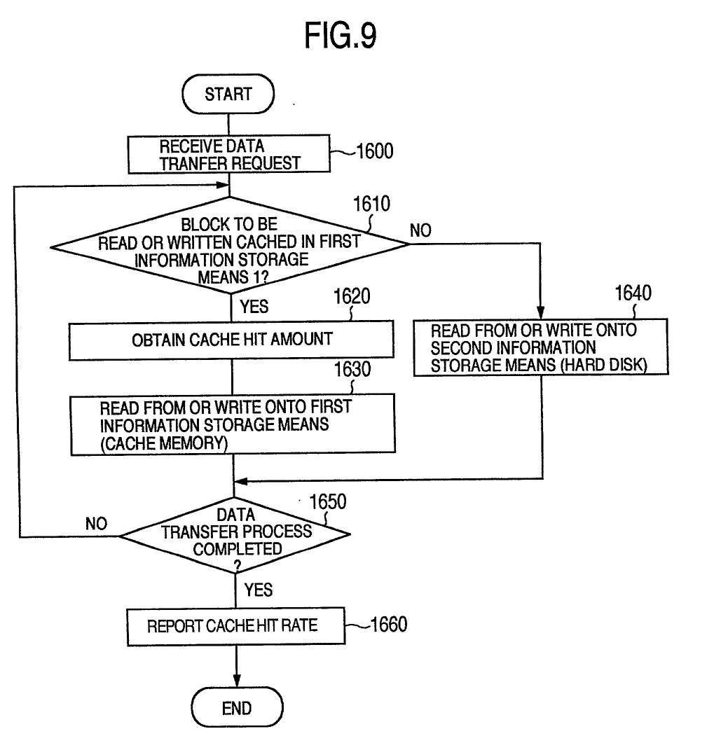

FIG. 9 is a flowchart showing steps of the physical device control process 440 performed by the disk adapter 550 upon receipt of a data transfer request from a channel adapter 500.

The disk adapter 550 receives the data transfer request from the channel adapter 500 in step 1600. The disk adapter 550 checks whether the data to be transferred is stored in the cache memory 450 in step 1610. If the data is stored in the cache memory, the disk adapter 550 obtains the amount of data cached, in step 1620. Thereafter, the disk adapter 550 performs data transfer to the cache memory 450 in step 1630.

If the data to be transferred is not stored in the cache memory 450, the disk adapter 550 performs data transfer to and from the hard disk drive 460 in step 1640.

Thereafter, the disk adapter 550 checks whether the data transfer has been completed or not, in step 1650. If the data transfer is not completed, the disk adapter 550 repeats the processes from step 1610 to step 1650. When the data transfer process has been completed, the disk adapter 550 calculates the cache hit rate on the basis of the amount of the data obtained. The cache hit rate is obtained by dividing the amount of the data cached, or the cache hit amount, by the total amount of data that has been transferred. Then, the disk adapter 550 reports the result of calculation to the channel adapter 500 in step 1660 to terminate the process.

As described above, the storage apparatus 400 obtains and stores therein the computer usage-status information 424. Upon receipt of a request for the computer usage-status information 424 from the management computer 300, the channel adapter 500b reads out the computer usage-status information 424 from the shared memory 490, and transmits the computer usage-status information 424 to the computer that has made the request. In this embodiment, the information acquisition request from the management computer 300 is sent to the port 404b. However, if the information acquisition request has been received at the port 404a, the channel adapter 500b can also report the computer usage-status information 424 in the same manner.

In this embodiment, I/O is classified into two types: read I/O and write I/O. Then, the I/O information is obtained and stored for each read or write I/O request. However, the I/O information may be collected in response to each I/O request command. For example, the I/O information may be obtained and stored in response to the Read (8) command, Read (10) command, Read (12) command, or Read (16) command, as described before.

Further, a specific management computer 300 may also be registered with the channel adapter 500b. In this case, the channel adapter 500b can execute the computer usage-status information reporting process 426 each predetermined time to read out the computer usage-status information 424 from the shared memory 490, and then can transmit the read computer usage-status information to the registered management computer 300. It means that the management computer 300 can store therein the computer usage-status information 424 on the time series, and can monitor the I/O performance of a computer 200 on the time series.

Still further, on the basis of the access performance information collected, an administrator can detect an overload on an internal device in the storage apparatus 400 and the breakdown of loads (a proportion between the computers from which I/O requests have been made and the I/O requests). Accordingly, a bottleneck in the performance of the computer system 1 can be readily spotted.

In this embodiment, the processes performed by the storage apparatus 400 are implemented by software and the processors that process instructions coming from the software. However, these processes can also be implemented by dedicated hardware that serves as these means.

Further, in other embodiment, a channel adapter may also have a combination of the functions of the channel adapter 500a and the channel adapter 500b. For example, a single channel adapter may handle both of I/O requests on the basis of the FCP protocol and I/O requests on the basis of the file sharing protocol. Alternatively, it may also be so arranged that a storage apparatus 400 comprises only a single sort of channel adapter that receives either one of I/O requests on the basis of the FCP protocol or I/O requests on the basis of the shared file protocol. Alternatively, a channel adapter may be dedicated to perform a single process exclusively. For example, a dedicated channel adapter for reporting I/O information may perform the computer usage-status information reporting process 426.

Further, even in a storage system having a single processor that serves both the functions of the channel adapter and the disk adapter for respectively performing processes with time slicing, the present invention can be practiced by using the processor with time slicing or dedicated hardware.

Next, a case where the SSP uses a storage apparatus according to the present invention will be described.

The SSP controls an association between a computer identifier and a customer who possesses or uses the computer identified by the computer identifier.

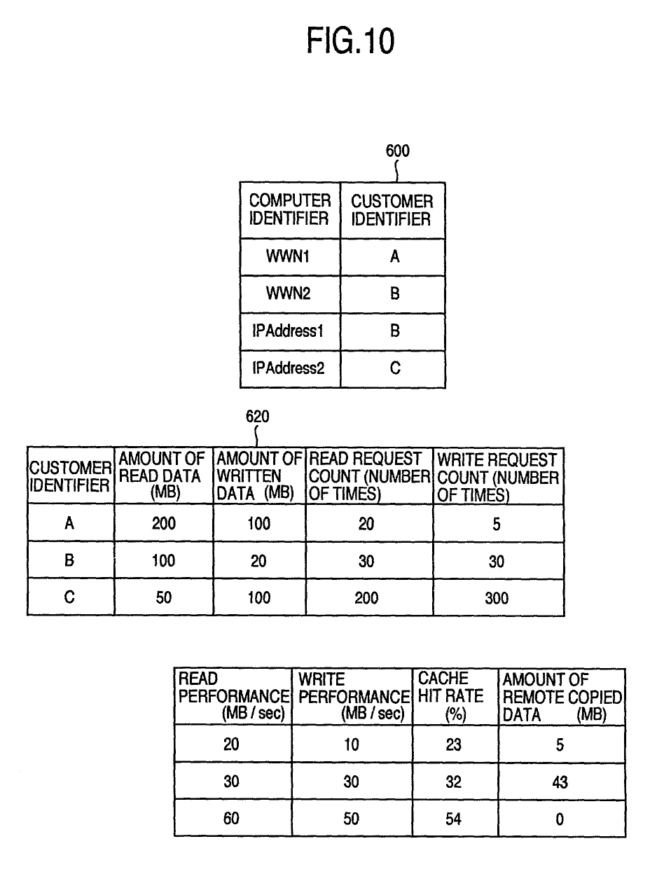

FIG. 10 shows a customer computer management table 600 set for managing the customers' usage statuses of the storage apparatus, by the use of the management computer. The SSP uses the customer computer management table 600 to control an association between a computer identifier and a customer identifier indicating a customer who possesses a computer identified by the computer identifier.

The SSP collects the computer usage-status information 424 reported from a plurality of the storage apparatuses 400, using the customer computer management table 600, for each customer. The information collected in this manner for each customer is customer usage-status information 620. The SSP further calculates the amount of read data, the amount of written data, the amount of remote copied data for each customer, calculates a charge according to the amount of read data, amount of written data, and amount of remote copied data, and then presents the calculated charge to the customer. For customers who attach importance on the I/O performance, the SSP calculates a charge according to the data transfer rate for the read and write operations. Alternatively, if a predetermined data transfer rate has not been achieved, the SSP gives a discount on the charge.

Further, in order to assist in monitoring the performance of the computer system by customers, the SSP uses the management computer 300 to make a report on I/O information for each customer computer on the basis of the computer usage-status information.

According to the present invention, in a computer system, the overall I/O performance of the computer system that even contains performance information inside a storage apparatus, can be obtained. In obtaining the I/O performance, no computer resources will not be used by agents.

Further, the management costs of the computer system can be reduced.

Still further, the SSP can provide charging service for customers, on the basis of the access performance to the storage apparatus. The SSP also can readily provide optional service that makes a report on I/O information for each customer computer.

It should be further understood by those skilled in the art that the foregoing description has been made on embodiments of the invention and that various changes and modifications may be made in the invention without departing from the spirit of the invention and the scope of the appended claims.

What is claimed is:

1. A storage apparatus connected to a plurality of computers via a network, comprising:
a controller including interface ports connected to the network for receiving I/O requests from the plurality of computers; and
storage devices connected to the controller;
wherein the controller further comprises memory connected to the controller, in which information on the I/O requests received at the interface ports is stored.

2. The storage apparatus according to claim 1, wherein the interface ports comprise an interface port for receiving a block I/O request and an interface port for receiving a file I/O request.

3. The storage apparatus according to claim 2, wherein the controller further comprises a crossbar switch for making an interconnection between the interface ports, the memory, and the storage devices.

4. The storage apparatus according to claim 3, wherein the controller further comprises a disk adapter for connecting the crossbar switch to the storage devices.

5. The storage apparatus according to claim 4, wherein the controller further comprises means for outputting the information on the I/O requests stored in the memory to an outside of the storage apparatus through the interface port.

6. The storage apparatus according to claim 5, wherein the information on the I/O requests is classified for each of the plurality of computers and then stored in the memory.

7. The storage apparatus according to claim 6, wherein the information on the I/O requests includes information on a device for which I/O has been requested, an amount of data that has been transferred, and data transfer performance.

8. The storage apparatus according to claim 1, wherein the controller further comprises a cache memory.

9. The storage apparatus according to claim 8, wherein the information on the I/O requests includes a cache hit rate in the cache memory when the I/O request has been made.

10. The storage apparatus according to claim 9, wherein the storage apparatus is connected to a second storage apparatus through the interface port.

11. The storage apparatus according to claim 10, wherein the controller further comprises means for copying data stored in the storage devices onto the second storage apparatus connected to the storage apparatus.

12. The storage apparatus according to claim 11, wherein information on an amount of data that has been copied by the means for copying is stored in the memory.

13. A method of charging users of a storage apparatus a fee for usage of the storage apparatus, the storage apparatus being connected to a plurality of computers via a network, the method comprising the steps of:
collecting information on an I/O request to the storage apparatus for each of the plurality of computers, by using the storage apparatus;
calculating an amount of data that has been transferred via the network for each of the plurality of computers, on the basis of the information collected in the preceding step;
calculating a fee for each of the plurality of computers, according to the calculated amount of data that has been transferred; and
charging each of the users of the plurality of computers the fee calculated in the step of calculating the fee.

14. The method of charging according to claim 13, further comprising the step of:
collecting information on an amount of data that has been transferred from the storage apparatus to a second storage apparatus for each of the plurality of computers, by using the storage apparatus.

15. The method of charging according to claim 14, wherein the step of calculating the fee further comprises the step of:
calculating a second fee for each of the plurality of computers, on the basis of the collected information on the amount of data that has been transferred;
wherein in the step of charging the fee, the charged fee includes the second fee.
